(19) United States
(12) Patent Application Publication
(10) Pub. No.: US 2026/0298201 A1
(43) Pub. Date: Oct. 1, 2026

(54) METHOD FOR CONTROLLING A WIND FARM

(71) Applicant: IFP Energies nouvelles, RUEIL-MALMAISON (FR)

(72) Inventor: Donatien DUBUC, RUEIL-MALMAISON CEDEX (FR)

(21) Appl. No.: 19/572,954

(22) Filed: Mar. 20, 2026

(30) Foreign Application Priority Data
Mar. 25, 2025 (FR) 2503075

(51) Int. Cl. F03D 7/04; F03D 7/02

(52) U.S. Cl. CPC F03D 7/049; F03D 7/0204; F05B 2260/84; F05B 2270/204; F05B 2270/32; F05B 2270/321; F05B 2270/8042

(57) ABSTRACT

The invention relates to a method for controlling a wind farm, with
A) a phase of initialization of maximization of the power generated by
   A1) implementation of an initial model for maximizing power generated by the wind farm via wake simulation, having initial parameters, for determining one or more initial operating points; and
   A2) application of these initial operating points to actuators of the wind turbines;
B) real-time acquisition of wind-bin measurements;
C) estimation of the parameters of the initial power-maximizing model with an estimator ESTIM based on wind-bin measurements;
D) updating the initial model with the estimate; phases B), C), and D) being reiterated, and a corrected model Mn obtained;
E) correcting of the maximization of the power generated.

### CROSS-REFERENCE TO RELATED APPLICATIONS

This application claims priority to French Patent Application 2503075, filed Mar. 25, 2025, which is incorporated herein by reference in its entirety.

### BACKGROUND OF THE INVENTION

### Field of the Invention

The present invention relates to the field of controlling wind farms so as to maximize the power generated and reduce wind-turbine fatigue.

### Description of the Prior Art

Wind farms, also known as wind parks or wind power plants, are sites where a plurality of wind turbines generates electricity. These sites may be on land or at sea. A distinction is thus made between onshore wind farms and offshore wind farms, i.e. those at sea.

The wind turbines of these farms are generally wind turbines with a horizontal axis of rotation, comprising a system for orienting the horizontal axis of rotation in the wind direction in order to maximize the power generated by the wind turbine. A wind turbine converts the kinetic energy of the wind into electrical or mechanical energy. To convert the wind's energy into electrical energy, a wind turbine comprises the following elements:
a tower making it possible to place a rotor at a sufficient height to allow its movement (which is necessary for horizontal-axis wind turbines) or to place this rotor at a height allowing it to be driven by wind that is stronger and more regular than at ground level.

The tower may house some of the electrical and electronic components of the turbine (modulator, controller, gearbox, generator, etc.);
a nacelle mounted at the top of the tower, housing mechanical, pneumatic and some electrical and electronic components required for operation of the machine (modulator, controller, gearbox, generator, etc.). The nacelle may rotate so as to orient the rotor in the right direction;
a rotor fastened to the nacelle, comprising a number of blades (generally three) and the nose cone of the wind turbine. The rotor is driven by the energy of the wind and is connected by a mechanical shaft directly or indirectly (via a system involving a gearbox and mechanical shaft) to an electric machine (electric generator, etc.) that converts the collected energy into electrical energy. The rotor is potentially equipped with control systems such as variable-angle blades or aerodynamic brakes;
optionally a transmission made up in particular of two axles (mechanical shaft of the rotor and mechanical shaft of the electric machine) connected by a transmission (gearbox).

Since the early 1990s, interest in wind energy has increased, particularly in the European Union, where the annual growth rate is about 20%. This growth is due to the inherent ability of wind energy to generate electricity without emitting carbon. In order to maintain this growth rate, the efficiency of wind turbines and of wind farms must continue to be improved. Increasing the amount of power generated from wind energy will require effective production tools and advanced control tools to be developed in order to improve machine performance. Wind turbines are designed to generate electricity at the lowest possible cost.

To regulate generated power, controllers have been designed for variable-speed wind-turbine generators. The objective of these controllers is to maximize generated electric power, minimize fluctuations in the speed of the rotor and minimize fatigue and extreme loading of the structure (blades, tower and platform).

Wind farms are subject to an effect commonly referred to as the “wake effect”, when disturbances created by turbines located upstream of the wind farm create suboptimal electricity-generation conditions for the other turbines. Specifically, a vortex wake forms downstream of a wind turbine, and in this wake average wind speed is decreased because some of the kinetic energy of the wind is captured by the wind turbine and because the turbulence level is increased. (The terms “upstream” and “downstream” are understood to mean the position of a wind turbine with respect to the other wind turbines in the direction of the prevailing wind at a given time.) More generally, when wind turbines are grouped together in a wind farm, under certain wind conditions, they may interact with one another through this wake effect. When a wind turbine harvests the kinetic energy of the wind, energy conservation leads to a loss of speed and an increase in turbulence in the downstream airflow. Wind turbines in this wake not only suffer from a significant drop in the generation of electrical power, but also increased mechanical fatigue. This effect is not negligible at the scale of a wind farm, as noted in the publication Barthelmie R J et al. “Quantifying the Impact of Wind Turbine Wakes on Power Output at Offshore Wind Farms” Journal of Atmospheric and Oceanic Technology 2010-08; 27 (8): 1302-17, which indicates that the power loss due to wake effects reached 12.4% and 23% in the Horns Rev and Lillgrund wind farms, respectively.

However, it is possible to influence wakes by controlling certain parameters, which may be modified with actuators of the wind turbines. One of these parameters is the yaw angle (also called the misalignment angle) defined as the angle between the wind direction and the axis orthogonal to the plane of the rotor, which allows the wake to be deflected, potentially allowing downstream wind turbines to harvest more energy. Techniques aiming to control wake are known as wake-steering methods.

To maximize their individual power generation, wind turbines are positioned orthogonally to the direction of the incident wind (i.e. the yaw angle is zero) in the standard yaw-control approach known as greedy control. Non-zero yaw angles result in a loss of turbine power. In wake steering, the objective is therefore to move away from a greedy strategy towards a holistic strategy maximizing the power delivered by the wind farm as a whole.

FIG. 1 illustrates the principle of wake steering: it is a view of a horizontal cross-sectional plane of two wind turbines, namely a wind turbine 1 that is upstream and a wind turbine 2 that is downstream with respect to a wind direction V, which has been represented by the parallel arrows. The upstream wind turbine 1 has a non-zero yaw angle Θ, deflecting its wake S1, and the wind turbine 2 downstream in the air flow has a zero misalignment (or yaw) angle θ and therefore harvests more energy, its wake S2 being in the same direction as the wind direction V.

To implement this type of strategy, the most widely used methods are based on so-called low-fidelity wind-farm models that predict total power depending on the wind conditions and the yaw angles of the wind turbines.

Since the computation time of these models is short, optimization methods may be used to determine which set of yaw angles Θ maximizes the total power of the wind farm, and then a look-up table that gives these yaw angles θ as a function of wind conditions may be generated.

This method has already been used on simulators (reference may be made to the publication Kheirabadi A C et al, “A Quantitative Review of Wind Farm Control with the Objective of Wind Farm Power Maximization”, Journal of Wind Engineering and Industrial Aerodynamics. 2019; 192:45-73) and experimentally (reference may be made to the publication Fleming P. et al. (“Field test of wake steering at an offshore wind farm”, Wind Energy Science. 2017; 2 (1): 229-39)).

However, this model-based method is very dependent on the quality of the model used for the optimization. Thus, any modelling errors will lead to an optimization that does not represent the true maximum output of the wind farm. To remedy this drawback, it has been proposed to use data-based methods or to adapt the models used to the measurements taken on the wind farm, in a so-called closed loop approach.

Thus, the publication Howland M F et al. (“Part 1: Conventionally Neutral Atmospheric Boundary Layer Conditions”, Wind Energy Science. 2020 Oct. 13; 5 (4): 1315-38) seeks to estimate in real time the parameters of a model described in the publication Shapiro C R et al. (“Modelling Yawed Wind Turbine Wakes: a Lifting Line Approach”. Journal of Fluid Mechanics. 2018 Apr. 25; 841:R1) using an ensemble Kalman filter to maximize total power only with power measurements. The method is tested with a LES simulator (LES being the acronym of “Large Eddy Simulation”). This publication shows that the closed-loop performance is not significantly better than the performance obtained with the open-loop method, even when the turbine power model is assumed to be perfectly known.

The goal of the invention is thus to overcome the drawbacks of the aforementioned methods, and its goal is in particular to provide an improved method for controlling a wind farm aiming to maximize the overall power generated by the farm.

A first subject of the invention is a method for controlling a wind farm, each wind turbine of the farm having at least one operating point, including its misalignment angle θ, that is adjustable by at least one actuator.

The method comprises:
A) a phase of initialization of maximization of the power generated by the farm, comprising:
   A1) a step of implementing an initial model MOD₀, in particular an analytical initial model, for maximizing the power generated by the wind farm via simulation of the wakes of the wind turbines, having given initial parameters, in order to determine one or more initial operating points, including the misalignment angle, of the wind turbines, and
   A2) a step of applying these initial operating points to actuators of the wind turbines,
B) a phase of real-time acquisition of wind-bin measurements,
C) a phase of estimation of the parameters of the initial power-maximizing model with an estimator based on the real-time wind-bin measurements obtained in acquisition phase B),
D) a phase of update of the parameters of the initial power-maximizing model with the estimate obtained in phase C), with a view to obtaining a corrected model;
   the successive phases B), C) and D) being reiterated n times in a first time interval P1, a corrected model updating the parameters of the corrected model of the previous iteration being obtained in each iteration, and
E) a phase of correction of the maximization of the power generated by the farm, comprising:
   E1) a step of implementing the corrected model obtained in step D) for maximizing the power generated by the wind farm, in order to determine one or more corrected operating points, including the misalignment angle, of the wind turbines, and
   E2) a step of applying this or these corrected operating point(s) to actuators of the wind turbines,
   the successive steps E1) and E2) being reiterated in a second time interval P2, which in particular is longer than the first time interval P1.

The invention has thus resulted in development of a new mode of wind-farm control, based on a power-maximizing model taking into account the wake of the wind turbines, that is able to remain relatively simple and economical in terms of computation/data processing (therefore not very resource intensive) and that is adapted/corrected in real time, using wind-bin measurements taken in the farm.

This new mode of control uses a closed-loop approach, which guarantees a closer alignment of the corrected model with the actual operation of the wind farm, leading to a better maximization of the overall power generated by the farm. (Here, the expression “closed loop” is understood to mean control with correction of the model, as opposed to “open loop” control, which rather relates to a pre-calibrated model.)

It is very advantageous to choose a time interval P2 in step E that is longer than the time interval P1 chosen in the reiteration of phases B), C), and D). Specifically, between each action, i.e. when new yaw-angle setpoints are sent to the wind farm, the wakes stabilize and hence the model to be estimated remains within its range of validity. Therefore, this time between two actions is “taken advantage of” to estimate the useful parameters as quickly as possible, because the estimation algorithms require a certain time before converging.

Advantageously, in phase A), the initial power-maximizing model may use the following initial parameters: the maximum amplitude U0 of the speed deficit, the width σ0 of the wake of the wind turbines, the amplitude kd of the deflection of the misalignment angle.

It may be seen that the initial model according to the invention is able to “get by” with only three parameters to be adjusted.

Advantageously, in phase A), the initial power-maximizing model may be a medium-fidelity dynamic simulator.

Specifically, this type of model is not very resource intensive, unlike so-called high-fidelity wake models, such as the SOWFA model developed by the National Renewable Energy Laboratory (NREL).

The terms “low-fidelity”, “medium-fidelity”, and “high-fidelity” have meanings, well known to those skilled in the art, that are used to characterize models (fidelity refers to the accuracy and precision of data representations and analyses, high fidelity often being indicative of low error rates and high coefficients of correlation between predicted and actual values).

Advantageously, in phase A), the initial power-maximizing model may consider steady wind bins (simplest model) or turbulent wind bins (more complex model).

Advantageously, in phase B), the wind bin, and in particular the distribution of wind speed of at least one of wind direction, and the wind speed may be measured by measuring means comprising at least one sensor, in particular a LIDAR or at least one anemometer.

For example, multi-beam flash LIDARs (in particular those employing four beams) allowing at least longitudinal wind speeds (along the axis of orientation of the wind) to be measured at several fixed distances may thus be used.

The measuring means may be fastened to the wind turbines, in particular on or in the vicinity of their nacelles. They may also be remote (for example, in the case of an offshore wind farm, mounted on floating buoys).

Advantageously, in phase C), the estimator may comprise an unscented Kalman filter.

In a dynamic context, where data arrive continuously over time (here real-time wind measurements), real-time estimation techniques, such as Kalman filters, are relevant. The unscented Kalman Filter (UKF) is particularly advantageous because, unlike the extended Kalman filter (EKF), this estimator has the advantage of being derivative-free, and hence it is unnecessary for the model equations to be explicit.

One example of an unscented Kalman filter is described in the publication Julier S J. et al. “A New Approach for Filtering Nonlinear Systems”. vol. 3. American Autom Control Council; 1995. p. 1628-32.

Advantageously, in phase C), the unscented Kalman filter (UKF) may estimate the state of the wind farm (also called the system) using a deterministic sampling technique and uses the unscented transform to calculate the statistical properties of the wind farm.

The successive phases B), C) and D) are preferably reiterated n times in a first time interval P1 of at most 10 seconds, in particular of at least 0.5 seconds, preferably between 1 and 5 seconds, and for example of 3 seconds.

The successive steps E1) and E2) are preferably reiterated in a second time interval P2 at least longer than the response time of the wind turbines to an actuator actuation command, in particular longer than 500 seconds, and for example of the order of 900 seconds.

The time required by the actuators to apply new operating points to all the wind turbines plus the time required by the wind turbines for their operation to stabilize at the new operating points is thus taken into account.

Another subject of the invention is a wind farm, that is a farm of wind turbines, each wind turbine of the wind farm having at least one adjustable operating point, including its misalignment angle, that is adjustable by at least one actuator associated with the wind turbine. The wind farm comprises or is connected to information technology implementing the control method described above in order to apply corrected operating points to the wind turbines of the farm, including their misalignment angle, through actuator control.

It is preferable for the information technology/computing devices to be hosted on the same site as the wind farm. However, it is also possible for them to be (completely or partly) located remotely from the site of the wind farm, provided that they may be connected to the wind farm by a high-performance communication network (Internet, etc.).

Another subject of the invention is any information technology, in particular a PC, server or computer, configured to implement the method for controlling a wind farm described above.

Another subject of the invention is any computer program product that is downloadable from at least one of a communication network and stored on a medium that is readable by a PC, server or computer and executable by a processor, comprising program code instructions for implementing the method for controlling a wind farm described above, when the program is executed on a PC, server or computer.

The invention also relates to any storage medium readable by a PC, server or computer and storing instructions that, when they are executed by a PC, server or computer, cause the PC, server or computer to implement the method for controlling a wind farm described above.

Other features and advantages of the method according to the invention will become apparent on reading the following description of non-limiting examples of embodiment, with reference to the appended figures, which are described below.

### BRIEF DESCRIPTION OF THE DRAWINGS

FIG. 1 shows a view of a horizontal cross-sectional plane of two wind turbines of a wind farm, the plane being at the height of the nacelles of the wind turbine, in order to illustrate the wind-turbine misalignment angle.

FIG. 2 shows one example of a block diagram of a method for controlling a wind farm according to the invention.

FIG. 3 shows in perspective three aligned wind turbines of a wind farm, each equipped with LIDAR with a view to implementing a method for controlling a wind farm according to the invention.

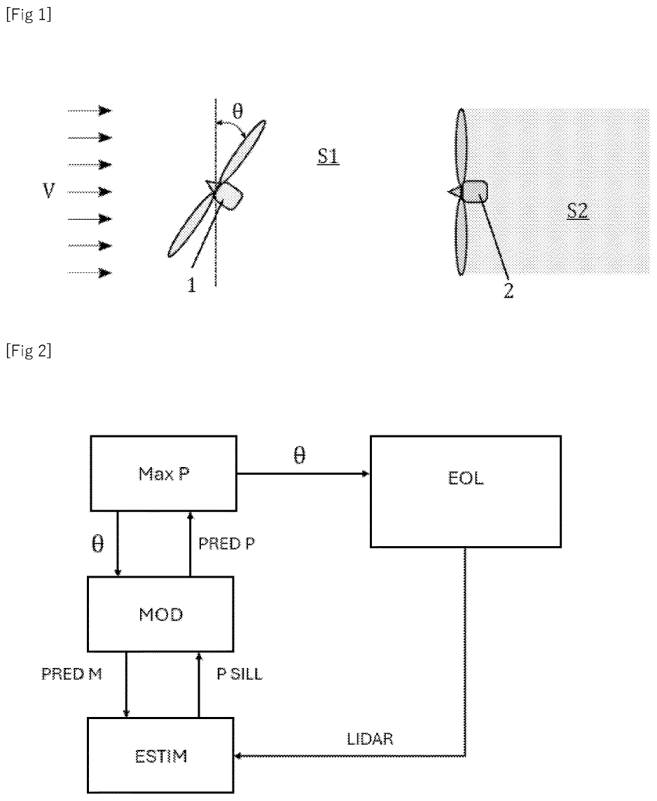

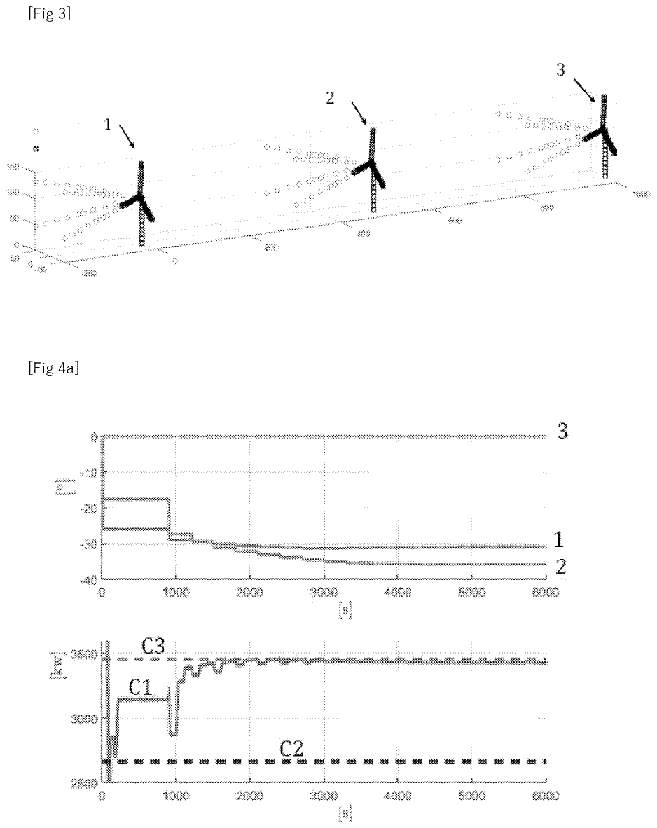

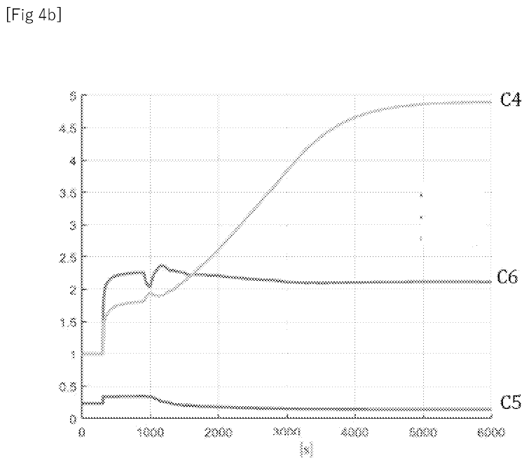

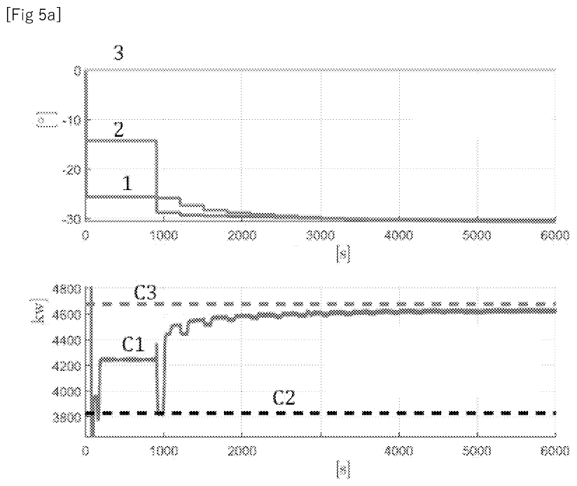

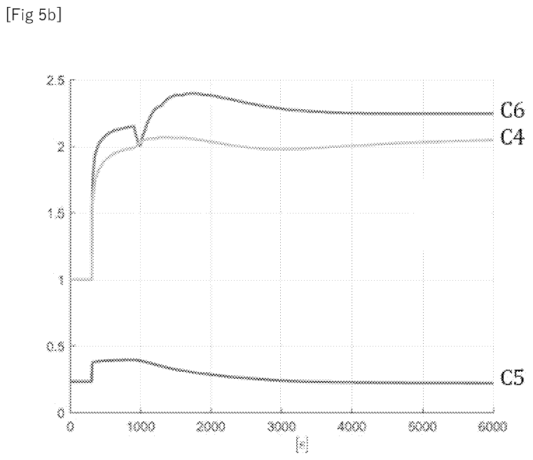

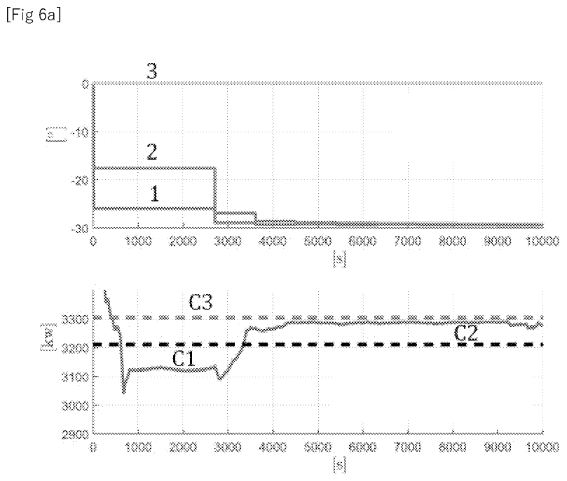

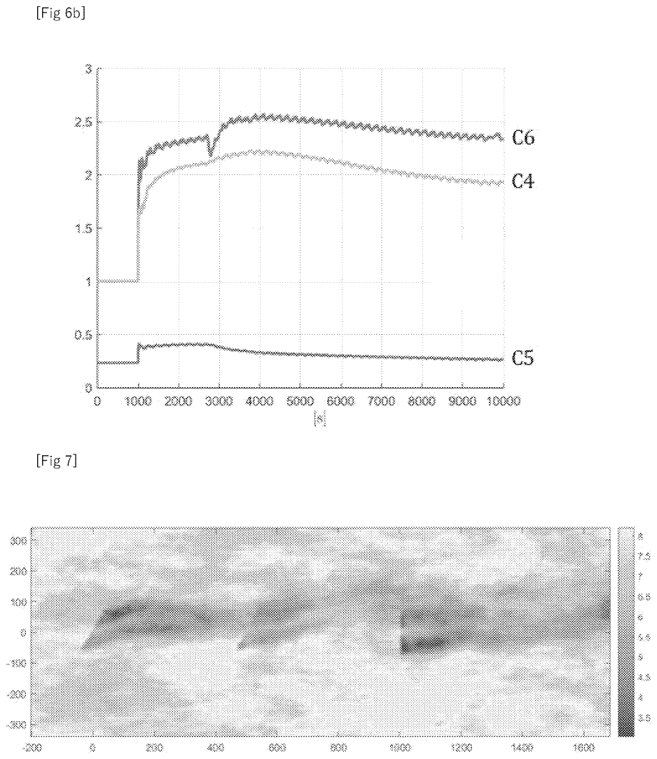

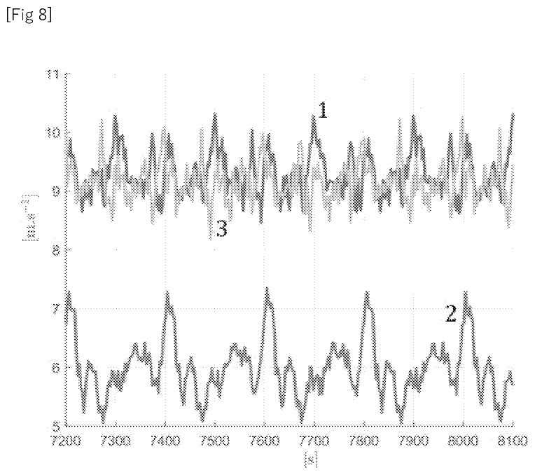

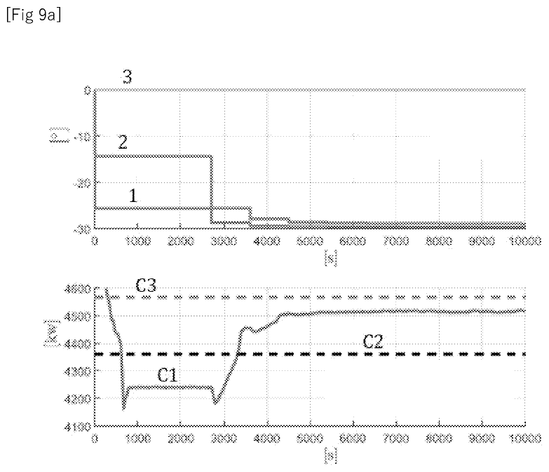

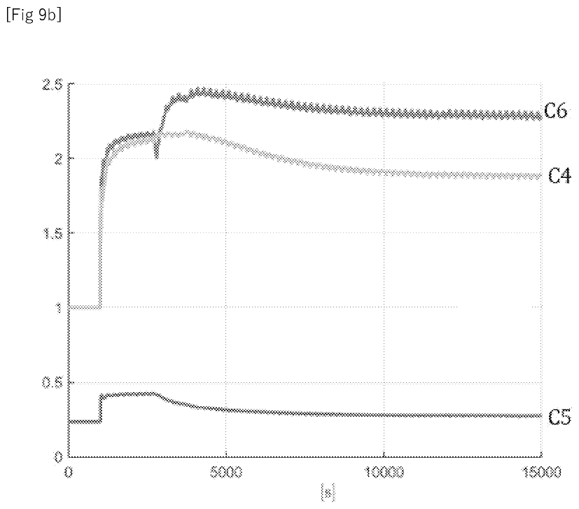

FIG. 4a shows two plots regarding a wind farm composed of three wind turbines 1, 2, 3 aligned as shown in FIG. 3, the x-axis of the graphs representing time expressed in seconds, and the y-axis of the graphs representing
as regarding the plots in the top part, the value of the misalignment angle θ for each of the three wind turbines 1, 2, 3, (turbine 1 being the furthest upstream of the three aligned wind turbines, with respect to the wind direction)
as regards the plots in the bottom part, the total power generated by the farm, under steady wind conditions of 8 m·s⁻¹, of the results obtained when the closed-loop control method according to the invention (curve C1), a prior-art “greedy” control method (curve C2) or a “data-driven control” method (curve C3) is applied.

FIG. 4b shows plots showing the variation, as a function of time expressed in seconds on the x-axis, of the three parameters of the model used: the maximum amplitude U0 of the speed deficit (curve C4), the width σ0 of the wake of the wind turbines (curve C5), the amplitude kd of the deflection of the misalignment angle after processing with a UKF estimator (curve C6), again under the steady wind conditions of 8 m·s⁻¹ of FIG. 4a.

FIG. 5a shows the same types of plots as FIG. 4a, but under steady wind conditions of 9 m·s⁻¹.

FIG. 5b shows the same types of plots as FIG. 4b, but under the steady wind conditions of 9 m·s⁻¹ of FIG. 5a.

FIG. 6a shows the same types of plots as FIG. 4a, but under turbulent wind conditions of 8 m·s⁻¹ with a turbulence intensity of 8%.

FIG. 6b shows the same types of plots as FIG. 4b, but under turbulent wind conditions of 8 m·s⁻¹ with the turbulence intensity of 8% of FIG. 6a.

FIG. 7 shows a simulated turbulent wind distribution, the greyscale being expressed in m/s.

FIG. 8 is a graph showing the measurements of wind speed, expressed in m·s⁻¹, as a function of time expressed in seconds, taken by each of the LIDARs with which each of the three wind turbines shown in FIG. 3 is equipped, for a fixed measured point at 90 metres in front of each of the wind turbines, under turbulent wind conditions.

FIG. 9a shows the same types of plots as FIG. 4a, but under turbulent wind conditions of 9 m·s⁻¹ with a turbulence intensity of 5%.

FIG. 9b shows the same types of plots as FIG. 4b, but under turbulent wind conditions of 9 m·s⁻¹ with the turbulence intensity of 5% of FIG. 9a.

All the figures, and in particular the depictions of the wind turbines, are very schematic, not necessarily to scale and do not necessarily show the actual spatial configuration of the wind turbines in their operating position.

### DETAILED DESCRIPTION OF THE PREFERRED EMBODIMENTS

### Definitions

Each wind turbine (also incorrectly referred to as a windmill) of the wind farm comprises at least one actuator for modifying at least one operating point of the wind turbine. Examples of actuatables are the misalignment angle θ (yaw) of the wind turbine with respect to the incident wind, the pitch angle of the blades, generator torque or rotor speed. An action on pitch angle, in coordination with generator torque or rotor speed, in particular makes it possible to throttle the turbine, thereby also reducing the wake effects it produces, or more generally to modify its power curve. Acting on misalignment angle allows the turbine to be aligned or misaligned with respect to the wind, depending on whether it is being attempted to maximize its individual generation or to divert the wake that it produces with a view to maximizing the overall generation of the farm.

The at least one actuator used may in particular be the actuator that controls at least one of the bearing of the nacelle, the actuators that control the orientation of the blades and the one or more actuators that control the counter-torque of the electric generator.

By “type” of wind turbine, what is meant in the present patent application is the fact that the wind farm in question may comprise only a single type of wind turbine (all the wind turbines are identical, operating in the same way and having the same dimensions in particular) or that the farm may comprise a plurality of types of wind turbines. In the latter case, the determination is carried out for each of the types of wind turbine.

By “misalignment angle θ”, what is meant in the present patent application is the angle between the axis orthogonal to the plane of the rotor and the direction of the wind (this angle is also called “yaw”).

By “throttling”, what is meant in the present patent application is reduction in the aerodynamic efficiency of the wind turbine in operation, in order for example to limit the electrical power generated thereby to a determined threshold, under given environmental conditions. It may result from a modification of at least one of the setpoint speed of rotation of the blades of the wind turbine and/or a modification of the orientation of the blades, thus modifying their angle of attack and their wind resistance.

By “wind bin”, what is meant in the present patent application is wind-related data, which may include the speed of the wind, its direction, its turbulence level, or even other environmental parameters, such as atmospheric stability.

In the present invention, the definition of the term “wake” is the known definition in the context of wind turbines, namely the region downstream of a wind turbine (with respect to the direction of the wind) where air flow is slowed (corresponding to the speed deficit considered here) and its turbulence level increased.

By “wind-speed deficit δ”, what is meant in the present invention is the wind-speed deficit produced by the wakes of wind turbines upstream of the wind turbine in question.

The present invention relates to a method for controlling in real time a wind farm, that is a farm of wind turbines, in order to maximize the power generated thereby, using a closed-loop approach, employing real-time wind measurement data.

The non-limiting embodiment of the invention described below with reference to the figures uses wind-bin data delivered by LIDAR (acronym of LIght Detection And Ranging), namely a remote-sensing technology that employs laser beams to measure, in particular, distances and movements in real time, by analysing the properties of the beams reflected to their emitters.

Wind farms, also known as wind parks or wind power plants, are sites where a plurality of wind turbines generates electricity. Each wind turbine (also incorrectly referred to as a windmill) of the wind farm comprises at least one actuator for modifying at least one operating point of the wind turbine. One example of an operating point is the misalignment angle θ (or yaw) of the wind turbine.

Other operating points may in particular be the throttling of the wind turbine, or the modification of the power curve of the wind turbine. The position of the wind turbines within the wind farm, also known as the arrangement or layout of the wind turbines, is known beforehand.

In the remainder of the description, only a description and examples of control of the misalignment angle θ are given.

However, other operating points may also be controlled by the control method according to the invention, in addition to misalignment angle; in particular the level of static, dynamic or helical induction control, which impacts the extent and advection of the wake, may be controlled.

For more details on dynamic induction control, reference may be made, for example, to the article “Periodic Dynamic Induction Control of Wind Farms: Proving the Potential in Simulations and Wind Tunnel Experiments” by J. A. Frederik et al., published in August 2019 in the publication Wind Energy Science Discussions.

For more details on helical induction control, reference may be made, for example, to the article “The Helix Approach: Using Dynamic Individual Pitch Control to Enhance Wake Mixing in Wind Farms”, by J. A. Frederik et al., published in August 2020 in the publication Wind Energy, issue 08, pages 1739-1751.

In the present patent application, the terms upstream and downstream are defined with respect to the direction of the wind (an upstream wind turbine is subjected to the wind before a wind turbine located downstream).

FIG. 2 schematically shows an overview of the closed-loop method for controlling a wind farm according to the invention, the various steps of which are described in more detail below.

To start with, the following are obtained:
a model MOD for maximizing the power generated by a farm, which model will subsequently be corrected but beforehand determines the maximum power MAX P that will define the misalignment angles to be applied to the wind turbines;
an estimator ESTIM, here for example a UKF;
a dynamic simulator, in particular a medium-fidelity dynamic simulator (when the control method is being applied to a simulation of a wind farm, to test it) or a real wind farm (when the control method is being applied to a real farm), both being designated in the figure by the reference EOL,
   the tools using or producing or controlling:
wind-bin measurements LIDAR measured by LIDARs (for example one LIDAR per wind turbine);
misalignment angles θ;
power predictions PRED P;
measurement predictions PRED M, corresponding to the estimations of the measurements
LIDAR by the model MOD;
wake parameters P SILL.

It may be seen that the model MOD to be adapted/corrected:
is fed with the wake parameters P SILL from the estimator ESTIM, itself fed with wind measurements obtained by the LIDARs;
produces power predictions PRED P to determine maximization parameters MAX P maximizing the overall power generated by the farm, leading to definition of the misalignment angles θ of the actual wind turbines of the farm or of the simulator EOL.

It may be seen that the estimator ESTIM:
is fed with the LIDAR measurements;
receives measurement predictions PRED M from the model MOD;
produces wake predictions P SILL that will be fed to the model MOD.

It may be seen that iterations are carried out to allow the model MOD to correct itself using the data provided by the estimator ESTIM: commands MAX P for misalignment angles θ are sent to the farm or simulator EOL, and values of misalignment angles θ are also returned to the model MOD with a view to processing thereby: the commands MAX P use the model MOD to find the misalignment angles, and the model MOD needs these angles to calculate a power.

The various blocks of the general schematic of FIG. 2 and their interactions will now be described in more detail.

### The Model MOD

A simplified wake model is selected for control purposes.

To simulate wake effects in wind farms, many models and software tools are available. These may be high-fidelity, such as SOWFA, which uses large-eddy simulation models, or low-fidelity, such as FLORIS, from NREL, or FarmShadow™, from IFPEN (in particular described in the publication F. Blondel et al. “Mixing-Length Approach for Analytical Wake-Added Turbulence Modelling in Wind Farms, WES (on-going), 2023” and in the publication F. Blondel et al. “An Adaptation of the Super-Gaussian Wake Model for Yawed Wind Turbines”, TORQUE 2020), which implement a number of “analytical” wake models (by “analytical” models what is understood is relatively simple models that, in theory, solely involve a mathematical formulation obtained experimentally; however, here what is meant is models using physical principles, and that are therefore not entirely analytical in the strict sense of the term). Due to their low computational cost, it is currently preferred to use low-fidelity models and software tools to control wind farms. They assume steady conditions, providing an average representation of the wind speed field of the wind farm over periods of a few minutes.

Although these models have been refined over the years, they have also become more complex, with a large number of parameters to adjust. To guarantee accurate and robust parameter adaptation, the model must be simple, with a limited number of parameters to be estimated having a significant influence on wake characteristics.

A new model is proposed here, inspired both by the publication Shapiro C R et al. “Modelling Yawed Wind Turbine Wakes: a Lifting Line Approach”. Journal of Fluid Mechanics. 2018 Apr. 25; 841:R1 as regards deficit, and by the publication Jiménez A et al. “Application of a LES Technique to Characterize the Wake Deflection of a Wind Turbine in Yaw”. Wind Energy. 2010-09; 13(6):559-72 as regards deflection:

$$Δ u = {U}_{0} ( \frac{1 - \sqrt{1 - {C}_{T}}}{8 {σ}_{0}^{2}} ) exp ( - \frac{1}{2 {σ}_{0}^{2}} {( y - {y}_{c} ( x ) )}^{2} )$$

with

$${y}_{c} ( x ) = {k}_{d} \times \frac{{C}_{T} sin γ}{4 {k}_{d 0}} ( 1 - \frac{1}{1 + 2 {k}_{d 0} x} )$$

where Δu is the speed deficit and C_{T} is the thrust coefficient. x and y are normalized by turbine diameter.

To obtain the speed at a turbine i, ui, the n unique upstream speed deficits evaluated at the downstream location are summed linearly:

$${u}_{i} = {U}_{∞} - {\sum }_{j = 1}^{n} Δ u$$

where U_{∞} is the freestream wind speed. It is then possible to obtain the speed field at the scale of the wind farm. In addition, the powers of the turbines are calculated using actuator disk theory. It is thus possible to deduce the total power of the farm and solve the following optimization problem:

$${γ}_{max} = {arg max}_{γ} {P}_{farm} ( γ )$$

where γ is a vector containing the yaw angles of the turbines and P_{farm} is the total power of the wind farm.

This equation is solved using Powell's BOBYQA algorithm (for more details, the interested reader may refer to the publication Powell M J. “The BOBYQA Algorithm for Bound Constrained Optimization Without Derivatives”. Cambridge NA Report NA2009/06, University of Cambridge, Cambridge. 2009; 26:26-46).

In this model (which is given merely by way of example), there are only three parameters to adjust: U0 which defines the maximum amplitude of the speed deficit, σ0 which defines the width of the wake and kd which influences the amplitude of the deflection of the yaw angle.

### The Simulator EOL

In the case where the control method of the invention is tested with a simulator and not an actual wind farm, the simulator may for example be the simulator FAST.Farm, a dynamic so-called medium-fidelity simulator, described in the publication Jonkman J M et al. “FAST.Farm User's Guide and Theory Manual”, National Renewable Energy Laboratory Golden, CO, USA; 2021). The simulator may also be the dynamic FarmShadow simulator mentioned above, which was developed by IFPEN and is of similar representativeness.

### The Estimator ESTIM

In a dynamic context, such as that of the simulator FAST.Farm (and of a real wind farm), where data arrives continuously over time, real-time estimation techniques, such as Kalman filters, are considered. Given that what it is a question of is a non-linear model of which there is a simulator, but no explicit mathematical formulation, something that is difficult to obtain, an unscented Kalman filter (UKF), as described in the aforementioned publication by Julier S J, will be employed. Unlike an extended Kalman filter (EKF), this estimator has the advantage of being derivative-free, so it is not necessary for the equations of the model to be explicit, something that is advantageous. The UKF estimates the state of the system using a deterministic sampling technique called sigma points and uses an unscented transform to calculate the statistical properties of the system.

Considering the following non-linear discrete system:

$${x}_{k} = f ( {x}_{k - 1} , {u}_{k - 1} ) + {v}_{k - 1}$$

$${y}_{k} = h ( {x}_{k} , {u}_{k} ) + {ϵ}_{k}$$

where:
xₖ is a vector of dimension n representing the state of the system,
uₖ₋₁ is the input vector, yₖ the output vector (or measurements), and vₖ and εₖ Gaussian white noise defined as follows:

$${v}_{k} \sim N ( 0 , Q ) and {ε}_{k} \sim N ( 0 , R ) .$$

To estimate the state xₖ with a UKF, the following steps must be carried out:
Calculation of the sigma points:

$${𝒳}_{k - 1} = [ {\hat{x}}_{k - 1} {\hat{x}}_{k - 1} + \sqrt{{α}^{2} ( n + κ )} \sqrt{{P}_{k - 1}} {\hat{x}}_{k - 1} - \sqrt{{α}^{2} ( n + κ )} \sqrt{{P}_{k - 1}} ]$$

(2) Temporal update equations:

$${𝒳}_{k} = f ( {𝒳}_{k - 1} , {v}_{k - 1} )$$

$${\hat{x}}_{k}^{-} = {\sum }_{i = 0}^{2 n} {w}_{i}^{( m )} {𝒳}_{i , k}$$

$${P}_{{x}_{k}} = 𝒬 + {\sum }_{i = 0}^{2 n} {w}_{i}^{( c )} ( {𝒳}_{i , k} - {\hat{x}}_{k}^{-} ) {( {𝒳}_{i , k} - {\hat{x}}_{k}^{-} )}^{T}$$

(3) Measurement update equations:

$${𝒴}_{k} = h ( {𝒳}_{k} , {u}_{k} )$$

$${\hat{y}}_{k}^{-} = {\sum }_{i = 0}^{2 n} {w}_{i}^{( m )} {𝒴}_{i , k}$$

$${P}_{{y}_{k}} = R + {\sum }_{i = 0}^{2 n} {w}_{i}^{( c )} ( {𝒴}_{i , k} - {\hat{y}}_{k}^{-} ) {( {𝒴}_{i , k} - {\hat{y}}_{k}^{-} )}^{T}$$

$${P}_{{x}_{k} , {y}_{k}} = {\sum }_{i = 0}^{2 n} {w}_{i}^{( c )} ( {𝒳}_{i , k} - {\hat{x}}_{k}^{-} ) {( {𝒴}_{i , k} - {\hat{y}}_{k}^{-} )}^{T}$$

### (4) Correction:

$${K}_{k} = {P}_{{x}_{k} , {y}_{k}} {P}_{{y}_{k}}^{- 1}$$

$${\hat{x}}_{k} = {\hat{x}}_{k}^{-} + {K}_{k} ( {y}_{k} - {\hat{y}}_{k}^{-} )$$

$${P}_{k} = {P}_{{x}_{k}} - {K}_{k} {P}_{{y}_{k}} {K}_{k}^{T}$$

where (·)i is the i-th column, with x₀ and P₀ given
\sqrt{Pₖ₋₁} can be calculated with a Cholesky decomposition.

The weight vectors w(^{m}) and w(^{c}) used to perform the unscented transform are given by:

$${w}_{0}^{( m )} = \frac{λ}{n + λ}$$

$${w}_{0}^{( c )} = \frac{λ}{n + λ} + 1 - {α}^{2} + β$$

$${w}_{i}^{( m )} = {w}_{i}^{( c )} = \frac{1}{2 ( n + λ )}$$

For all, i=1, . . . , 2n
with λ=α²(n+κ)−n

The parameters α, β and κ influence the distribution of the sigma points. Their usual values are:

$$α = 1 {0}^{- 3}$$

$$β = 2$$

$$κ = 0.$$

In order to adjust the UKF, the covariance matrices Q and R, which are generally unknown, are used to influence the convergence rate and noise robustness of the filter.

In the present case,

$${\hat{x}}_{k} = [ {U}_{0} , {{σ}_{0}}^{⌣} , {k}_{d} ] , \hat{f} ( {\hat{x}}_{k - 1} , {u}_{k - 1} )$$

$$and$$

$${\hat{y}}_{k} = h ( \underline{{\hat{x}}_{k}} , {u}_{k} )$$

correspond to the LIDAR measurement points given by the model described above. Specifically, in the present configuration, each wind turbine has a four-beam multi-range flash LIDAR on its nacelle, allowing longitudinal speed measurements at a number of fixed distances. This LIDAR corresponds to that used in the publication Guillemin F et al. “Real-time three dimensional wind field reconstruction from nacelle LIDAR measurements” (Journal of Physics: Conference Series. June 2018; 1037(3):032037), measuring wind speed at ten distances from 50 to 200 metres.

FIG. 3 illustrates the measurement points (symbolized by circles aligned in 4 different directions extending from each turbine), considered in a wind farm of three aligned wind turbines 1, 2, 3, each turbine being spaced apart by four diameters from the adjacent turbine.

### Simulator Configuration

DWM models (DWM standing for Dynamic Wake Meandering) are very useful for control purposes, as they are relatively rapid to evaluate and capture dynamic effects. These models describe wakes by use of a succession of tracers, to which static models are applied. These tracers are then advected according to the incoming air flow. The simulator FAST. Farm is based on these principles, coupled with OpenFAST aerodynamic models (as described in NREL. Github OpenFAST repository; 2024. https://github.com/OpenFAST/openfast) allowing individual wind turbines to be controlled, while simulating the dynamic propagation of the wakes through the wind farm.

To control the various wind turbines, FAST.Farm uses a dynamic link library (DLL) called Super Controller (SC), which communicates with OpenFAST instances that simulate the behaviour of individual wind turbines using standardized DISCON controllers that are well known in the field.

Within the context of the work leading to the present invention, an open-source interface (see IFP energies nouvelles. Github WFCRL repository; 2024. https://github.com/ifpen/wfcrl-env) has been developed. This interface uses an MPI channel (MPI standing for Message Passing Interface) to communicate between Python and FAST.Farm, allowing yaw-angle θ and pitch-angle references and a generator torque to be imposed on the various wind-turbine controllers. The interface may also be used to retrieve measurements from these controllers, such as measurements of electrical power. In addition to deploying the interface, the FAST.Farm executable has also been modified to make it able to simulate LIDAR measurements such as those described in FIG. 3.

### Implementation of the Control Method According to the Invention in Closed-Loop Mode

Full closed-loop control may now be implemented in FAST.Farm. The wind farm has of 3 aligned NREL-5MW turbines, spaced apart by four diameters (the diameter is 126 metres) as shown in FIG. 3.

These turbines are in particular described in the publication Jonkman J. et al. “Definition of a 5-MW Reference Wind Turbine for Offshore System Development”, in Technical Report NREL/TP-500-38060 of February 2009 by the National Renewable Energy Laboratory.

The model MOD used to effect the control is the one described above, with the vector of parameters to be estimated: xₖ=[U0, σ0, kd].

The UKF uses LIDAR measurements as shown in FIG. 3.

Lastly, every td seconds (which corresponds to one example of an interval P2 as mentioned above, whereas the interval P1 mentioned above corresponds, for its part, to the frequency of the measurements taken by the LIDARs, which may for example be of the order of one second), the adapted model is used to maximize the total power generated by the farm, by updating the yaw angles θ via the BOBYQA algorithm of Powell that was described above.

The procedure is illustrated in FIG. 2 described above.

### Results

### EXAMPLE 1

To test the algorithm, a scenario in which the wind remained steady at a speed of 8 m·s⁻¹ was first considered.

In this turbulent-free case, the yaw angle update rate was τd=300 s.

The obtained results are presented in FIG. 4a, which shows the variation in the yaw angles θ and total power of the wind farm for each of the three wind turbines 1, 2 and 3, and FIG. 4b, which shows the variation as a function of time in the estimates of the parameters of the model.

After the initialization phase, FIG. 4a shows that the algorithm converged to the yaw angles θ [−30.9, −35.7.0]° after 3000 s, corresponding to a total power of 3433 kW.

The desired effect was clearly present: a significant increase in power, of almost 9.2%, was observed compared to the initial estimate (curve C1 according to the invention), and more than 28.7% compared to the case of greedy control (curve C2) where all the turbines have a yaw angle θ of zero.

To know how close the power so optimized got to the maximum power that the wind farm was able to deliver, a data-driven algorithm such as the one presented in the publication Bizon Monroc C. et al. (“Actor Critic Agents for Wind Farm Control.” 2023, American Control Conference (ACC). 2023:177-83) was also tested.

Such a model-free method works on a trial-and-error basis, and therefore gets very close to the true maximum. The final value obtained (after a very long time) is shown in FIG. 4a: it may be seen that it is very close (curve C3) to the final value obtained with the method according to the invention.

FIG. 4b also shows convergence of the parameters; however, curve C4, which regards the parameter U0, seems to converge more slowly than curve C5, which regards the parameter σ0, and curve C6, which regards the parameter kd.

It is possible to make provision to more aggressively parametrize the UKF to further improve the response time of the method according to the invention, i.e. to calibrate it so that it converges more rapidly, possibly at the expense of its sensitivity to measurement noise.

### EXAMPLE 2

To test the method under other wind conditions, the freestream wind speed was then set to 9 m·s⁻¹.

The results are presented in FIGS. 5a and 5b. The observed performance was similar to that obtained previously at 8 m·s⁻¹: the yaw angles θ converged after about 3000 seconds in the case of curve C1 of the method according to the invention, and an improvement of 22.4% with respect to the greedy control strategy (curve C2) was obtained. Once again, the power obtained was very close to the actual maximum power (curve C3).

Thus, even under different wind conditions, the method according to the invention managed to significantly increase the total power of the wind farm.

### EXAMPLE 3

To make the case as realistic as possible, a turbulent wind flow with a speed of 8 m·s⁻¹ at hub height and a turbulence intensity of 8% was also considered.

An overview of the field of this turbulent wind with a speed of 8 m·s⁻¹ and a turbulence intensity of 8% is given in FIG. 7, as simulated with FAST.Farm: It will be noted that the wind field was not at all uniform, both spatially and temporally.

A sample of the LIDAR measurements taken for the three wind turbines in the context of Example 3 is shown in FIG. 8 (temporal zoom) for a point located 90 metres in front of the three turbines. The light-grey curve, curve 3, corresponds to wind turbine 3, the black curve, curve 1, in the top part of the graph corresponds to wind turbine 1, and the curve in the bottom part corresponds to wind turbine 2, as indicated in the figure.

In this case, τd=900 s (corresponding to the interval P2 mentioned above).

The closed-loop control power was here averaged over 10 minutes for the sake of better legibility.

The results are illustrated in FIGS. 6a and 6b. For these wind conditions, the yaw angles θ converged to [−29.6, −29.8, 0]° after 6000 s, corresponding to an average total power of 3288 kW.

As in the steady case of Examples 1 and 2, the algorithm stabilized well, with a clear increase in total power obtained by means of closed-loop control (curve C1 according to the invention).

FIG. 6a also shows (curve C2) the power obtained in open-loop mode: the corresponding yaw angles θ were deduced from a FLORIS configuration and calculated using the algorithm Serial Refine described in the publication Fleming P A et al. “Serial-Refine Method for Fast Wake-Steering Yaw Optimization”. Journal of Physics: Conference Series. 2022; 2265 (3):032109.

It may be seen that the closed-loop control strategy according to the invention (curve C1) considerably improved the power generated by the farm compared to the open-loop strategy (curve C2), even though the model is much less accurate.

It may also be seen that, with the method of the invention, the power so optimized got very close to true maximum, obtained with the data-driven method (curve C3).

FIG. 6b also shows convergence of the parameters with curve C4 regarding the parameter U₀, curve C5 regarding the parameter σ₀ and curve C6 regarding the parameter k_{d}, in a similar way to FIG. 4b.

### EXAMPLE 4

Similarly to Example 3, the method was repeated but for a turbulent wind of 9 m·s⁻¹ with a turbulence intensity of 5%. The results, illustrated in FIGS. 9a and 9b, show a behaviour similar to the turbulent case of Example 3 above: convergence was reached around 6000 seconds (curve C1), and there was a notable increase in total power over time.

Likewise, the closed-loop power (curve C1) was greater than the open-loop power (curve C2), and the method of the invention again allowed the true maximum to be approached.

This demonstrates that the method may be effectively tailored to various wind conditions, and in particular steady or turbulent wind conditions.

In conclusion, in this series of examples, an algorithm allowing full closed-loop control of a wind farm was tested on FAST.Farm.

This algorithm consisted in adapting the described model in real time using as estimator a UKF. The adapted model was then used to find a set of yaw angles θ maximizing the total power generated.

These angles were then transmitted to FAST.Farm via an interface, which in turn delivered LIDAR speed measurements to the estimator.

Two cases were therefore studied: one where the wind remained steady, and the other, closer to reality, where the wind field was turbulent.

In both cases, a significant increase in the total power delivered by the wind farm was observed.

The turbulent scenario, in particular, highlights the robustness of the method: even with a more realistic simulator, a simple model with few parameters to adapt like the one used in the method according to the invention allows good results to be obtained using a closed-loop approach.

The studied cases also showed that, with the invention, the generated power can get very close to the true maximums found with a data-driven method, and that the powers obtained with an open-loop method are systematically exceeded.

It should be emphasized that with the invention it is possible to estimate the general parameters that define the wake models (speed deficit, width of the wakes and deflection in particular) and not just a single parameter that would be limited to estimation of the wake angle alone for example.

1-11. (canceled)

12. A method of controlling a wind farm with wind turbines of the farm including at least one operating point, including a misalignment angle, that is adjustable by at least one actuator, comprising:
A) initializing of maximization of the power generated by the farm by steps comprising:
A1) implementing an analytical initial model, for maximizing power generated by the wind farm via simulation of wakes from the wind turbines, having initial parameters, for determining one or more initial operating points, including misalignment angles, of the wind turbines;
A2) applying initial operating points to actuators of the wind turbines,
B) acquiring real-time wind-bin measurements;
C) estimating parameters of an initial power-maximizing model with an estimator based on the real-time wind-bin measurements obtained in phase B);
D) updating the parameters of the initial model for maximizing power with the estimate obtained in C), for obtaining a corrected model, the successive steps B, C and D being reiterated n times in a first time interval P1 with a corrected model updating the parameters of the corrected model of a previous iteration being obtained in each iteration; and
E) correcting maximization of the power generated by the farm, comprising:
E1) implementing the corrected model obtained in step D) to maximize the power generated by the wind farm, for determining at least one corrected operating point, including the misalignment angle of the wind turbines; and
E2) applying at least one corrected operating point to actuators of the wind turbines; wherein
steps E1) and E2) are reiterated in a second time interval P2, which is longer than a first time interval P1.

13. A method of controlling a wind farm according to claim 12, wherein in A), the initial power-maximizing model uses parameters of a maximum amplitude of a speed deficit, a width of wake of wind turbines and an amplitude of deflection of the misalignment angle.

14. A method of controlling a wind farm according to claim 13, wherein in A), the initial power-maximizing model is a dynamics simulator.

15. A method of controlling a wind farm according to claim 13, wherein the dynamics simulator is a medium-fidelity dynamic simulator.

16. A method of controlling a wind farm according to claim 14, wherein in A), the initial power-maximizing model is a dynamics simulator.

17. A method of controlling a wind farm according to claim 15, wherein in A), the initial power-maximizing model is a dynamics simulator.

18. A method of controlling a wind farm according to claim 12, wherein in A), the analytical initial power-maximizing model considers steady or turbulent measurements in the wind bins measurements.

19. A method of controlling a wind farm according to claim 12, wherein in B), at least one of distribution of wind speed, wind direction, and at least one of wind speed and wind direction, is measured by measuring with at least one LIDAR sensor and at least one anemometer.

20. A method of controlling a wind farm according to claim 12, comprising means for measuring are fastened to the wind turbines, in a vicinity of nacelles of the wind turbine, or are remote from the nacelles.

21. A method of controlling a wind farm according to claim 12, wherein in C), the estimator comprises an unscented Kalman filter.

22. A method of controlling a wind farm according to claim 21, wherein in C), the unscented Kalman filter estimates a state of the wind farm using deterministic sampling and uses an unscented transform to calculate statistical properties of the wind farm.

23. A method of controlling a wind farm according to claim 12, wherein in B), C) and D) times are reiterated by n times in a first time interval P1 of less than 10 and at least 0.5 seconds.

24. A method according to claim 23, wherein interval P1 is at least 0.05 seconds.

25. A method according to claim 23, wherein P1 is between 1 and 5 seconds.

26. A method for controlling a wind farm according to claim 12, wherein E1) and E2) are reiterated in a second time interval P2 longer than 500 seconds response time of the wind turbines to an actuator actuation command which is longer than 500 seconds.

27. A wind farm, of wind turbines, wherein each wind turbine of the wind farm has at least one adjustable operating point, including a misalignment angle, that is adjustable by at least one actuator associated with the wind turbine, wherein the wind farm comprises or is connected to information technology implements the control method according to claim 12 to apply corrected operating points to the wind turbines of the farm, including the misalignment angle, by an actuator control.
